(19) United States
(12) Patent Application Publication
(10) Pub. No.: US 2013/0020800 A1
(43) Pub. Date: Jan. 24, 2013

(54) DEVICE FOR COUPLING FLUID-CIRCULATION TUBES AND RELATED METHOD

(71) Applicants: Stéphane Heraud, Paris (FR); Benoît Artaud, Paris (FR)

(72) Inventors: Stéphane Heraud, Paris (FR); Benoît Artaud, Paris (FR)

(73) Assignee: PERMASWAGE, Les Clayes Sous Bios (FR)

(21) Appl. No.: 13/574,172

(22) PCT Filed: Jan. 19, 2011
(86) PCT No.: PCT/FR2011/050090

§ 371 Date: Oct. 2, 2012

(30) Foreign Application Priority Data
Jan. 20, 2010 (FR) 1050350

(51) Int. Cl. F16L 19/028

(52) U.S. Cl. 285/382.1

(57) ABSTRACT

A device for coupling fluid-circulation tubes includes a first coupling connecting first and second tubes, in which first coupling the respective ends of the first and second tubes are arranged coaxially aligned with one another. At least one of the opposite ends of the first and second tubes is capable of being secured to a second coupling, which is configured to couple the first or second tube to a pipe of a fluid circuit, the second coupling including at least one portion made in one piece with the opposite end of the tube in question, such that the portion of the second coupling forms the opposite end of the tube in question.

The invention relates to a device for coupling fluid-circulation tubes and a method for creating such a device.

The invention relates more particularly to gas or liquid circulation tubes installed in an aircraft.

More particularly, the invention relates to the nitrogen circuits of the aircraft fuel tanks subjected to a nominal pressure of 15 bars. The pipes of these circuits pass through the fuel tank and have to ensure the necessary resistance to chemical products and in particular to kerosene.

The invention also applies to cooling liquid circuits operating at pressures around 15 bars.

Finally, the invention also relates to oxygen circuits as well as pressurised liquid hydraulic circuits for flight controls or landing gear controls subjected to pressures of the order of 350 bars.

The circulation of fluids, particularly when they are liquids in metal pipes, can generate the formation of electric charges.

Tube couplings are known which avoid the accumulation of electric charges resulting from the circulation of fluids, whilst at the same time ensuring secure circulation of these fluids through two tubes, the respective ends whereof are held coaxially with respect to one another.

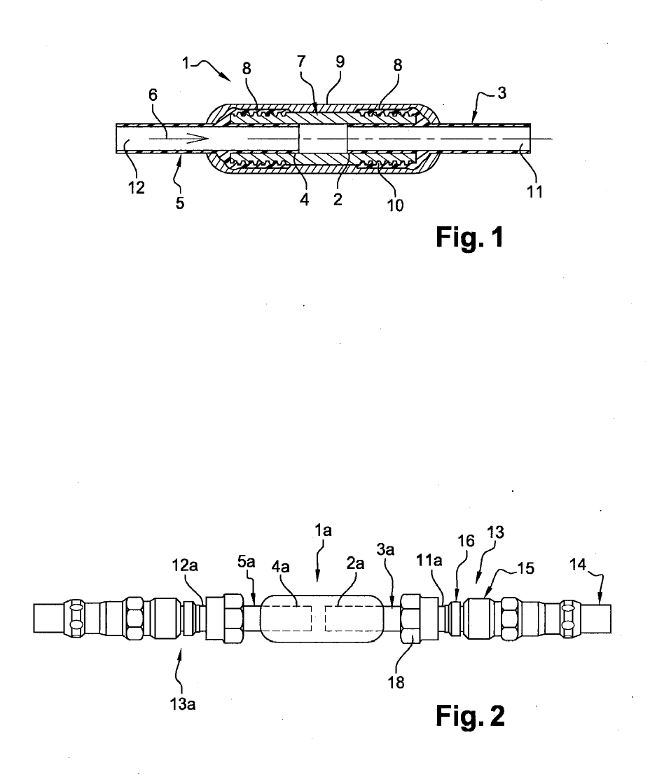

A coupling of this type is known in particular from publication US 2008/0169643. This coupling is a dielectric coupling which is described by reference to FIG. 1 representing a schematic cross-sectional view of this coupling.

In dielectric coupling 1, end 2 of a first tube 3 and end 4 of a second tube 5 are held fixed relative to one another.

More precisely, these two ends 2 and 4 are disposed coaxially with respect to one another in such a way that the fluids circulating along arrow 6 pass through coupling 1 in a secure manner.

This coupling 1 comprises a non-metallic hydraulic pipe 7 which provides the connection between first 3 and second 5 tubes.

This metallic hydraulic pipe 7 is fitted onto respective ends 2, 4 of these two tubes 3, 5 which each comprise a metal socket 8 extending axially along and to a certain distance of this tube 3, 5 in the direction of its respective end 2, 4, and having hooks 10 which firmly hold hydraulic pipe 7 between metal sockets 8 and end 2, 4 of each of these first 3 and second 5 tubes.

Metallic hydraulic pipe 7 is made from several non-metallic layers not represented in this figure and which comprise in particular a layer permitting the electrical resistance of electric coupling 1 to be controlled, for example a carbon layer.

The dielectric coupling also comprises an envelope 9 which completely covers metallic hydraulic pipe 7 and partially the two pipes 3, 5, for which it provides the connection.

If this electric coupling 1 permits the electric energy generated by the circulation of the fluids to be dissipated, first tube 3 and tube pipe 5, for which it provides the connection, must be connected to the rest of the fluid circuit by their opposite ends 11, 12. This problem is also present for the coupling described in publication U.S. Pat. No. 5,973,903.

In this context, the invention is aimed at a device for coupling tubes permitting coupling of the opposite ends of the tubes connected by a first coupling, for example the dielectric coupling described above, to a pipe of a fluid circuit.

For this purpose, the device for coupling fluid-circulation tubes of the invention comprises a first coupling connecting a first and a second tube, in which first coupling the respective ends of the first and second tubes are disposed coaxially with respect to one another. This device is essentially characterised in that at least one of the opposite ends of the first and second tubes is capable of being secured to a second coupling which is intended for coupling the first or second tube to a pipe of a fluid circuit, said second coupling comprising at least one portion which is made in one piece with the opposite end of the tube in question, such that this portion of the second coupling forms the opposite end of the tube in question.

The device for the coupling of tubes of the invention can also comprise the following optional features considered in isolation or in all the possible technical combinations:
the second coupling comprises at least one crimping zone which endows it with the capacity to be fixed by a crimping operation at the end of the pipe of a fluid circuit.
the second coupling is a sleeve forming the opposite end of the tube in question and comprising at least one crimping zone providing the crimping of the pipe by application of a radial compressive force in this crimping zone.
the sleeve comprises a collar forming crimping means by axial displacement along said sleeve during the crimping operation.
the second coupling comprises a first coupling portion forming end of the tube in question, said first coupling portion is capable of being held fixedly relative to a second combined coupling portion which is secured to the pipe of the fluid circuit, these first and second coupling portions in their fixed position relative to one another comprising means providing for the secure circulation of the fluids through the second coupling.
the first coupling portion and the second combined coupling portion comprise fixing means rendering them capable of being held fixedly relative to one another in such a way as to be detachable by a screw nut.
the first coupling is a dielectric coupling comprising means capable of dissipating the electric energy generated by the movements of fluids circulating in the first and second tubes.
each of the opposite ends of the first and second tubes comprises a second coupling comprising at least one portion which is made in one piece with the opposite end of the tube in question.
the first (3a) and second (5a) tubes as well as the pipe (14) are metallic.

The invention also relates to a method for using the previously described device, i.e. a device which comprises a first coupling connecting a first and a second tube, in which first coupling the respective ends of the first and second tubes are disposed coaxially with respect to one another, in which device at least one of the opposite ends of the first and second tubes is capable of being secured to a second coupling which is intended to couple the first or second tube to a pipe of a fluid circuit, said second coupling comprising at least one portion which is made in one piece with the opposite end of the tube in question, said method comprising at least one step for machining this portion of the second coupling at the end of the tube in question.

Other features and advantages of the invention will emerge clearly from the description thereof given below, by way of indication and on no account limiting, making reference to the appended figures, among which:

FIG. 1 already described represents schematically in cross-section a dielectric coupling of the prior art as well as a part of the first and second tubes for which it provides the connection;

FIG. 2 represents schematically a device for coupling tubes comprising a first coupling for dissipating the electric charges and two second couplings intended to connect respectively the first and second tube to a pipe (not represented) of the fluid circuit;

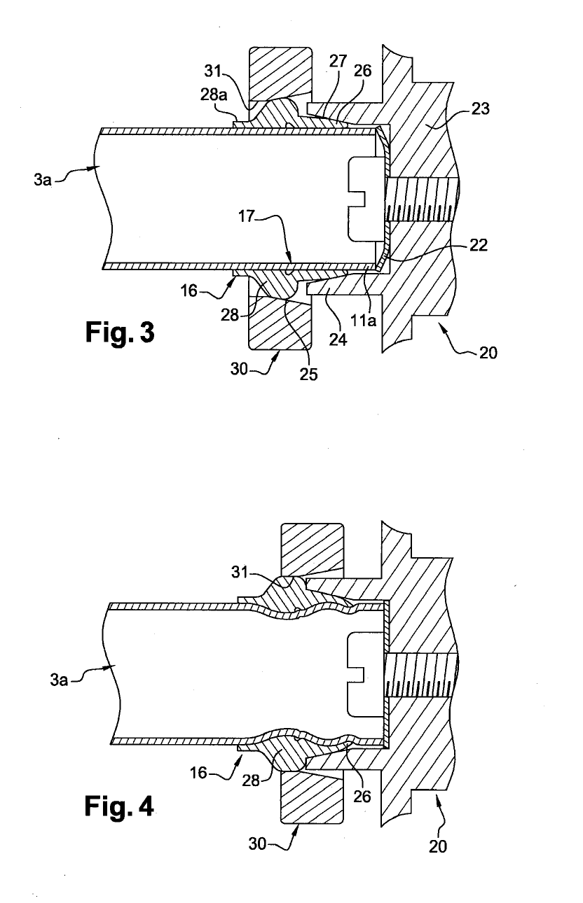

FIG. 3 is a schematic cross-sectional view of a portion of the second coupling of FIG. 2 before crimping;

FIG. 4 is the same view as that of FIG. 3 and represents schematically in cross-section a portion of the second coupling after crimping;

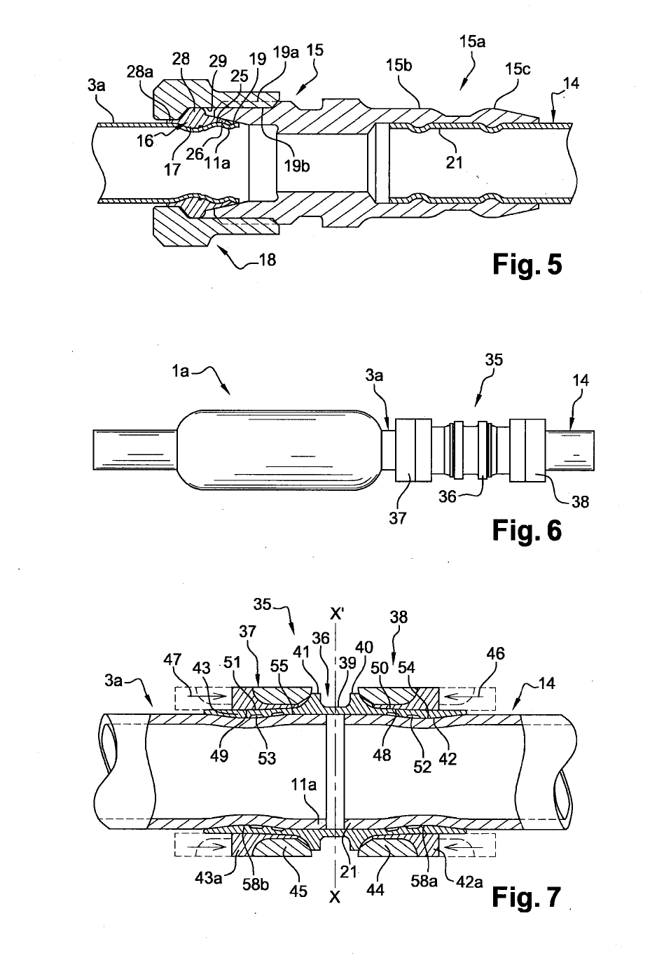

FIG. 5 represents the second coupling of FIG. 3 with the bolt in its position securing the two portions of this second coupling;

FIG. 6 represents schematically a device for coupling tubes comprising a first coupling for dissipating the electric charges and a second coupling connecting the first tube to a pipe of the fluid circuit;

FIG. 7 is a schematic cross-sectional view of the second coupling of FIG. 6 during the crimping operation;

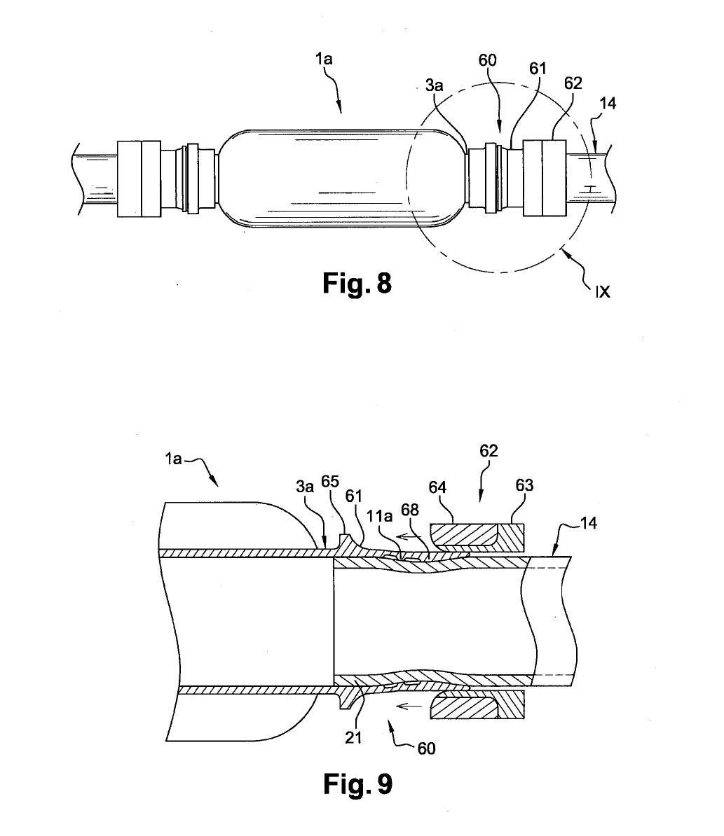

FIG. 8 represents schematically a device for coupling tubes according to a first variant of the invention comprising a first coupling for dissipating the electric charges and two second couplings connecting respectively the first and second tube to a pipe of the fluid circuit;

FIG. 9 is a cross-sectional view of circled part IX of FIG. 8 mainly representing the second coupling after crimping;

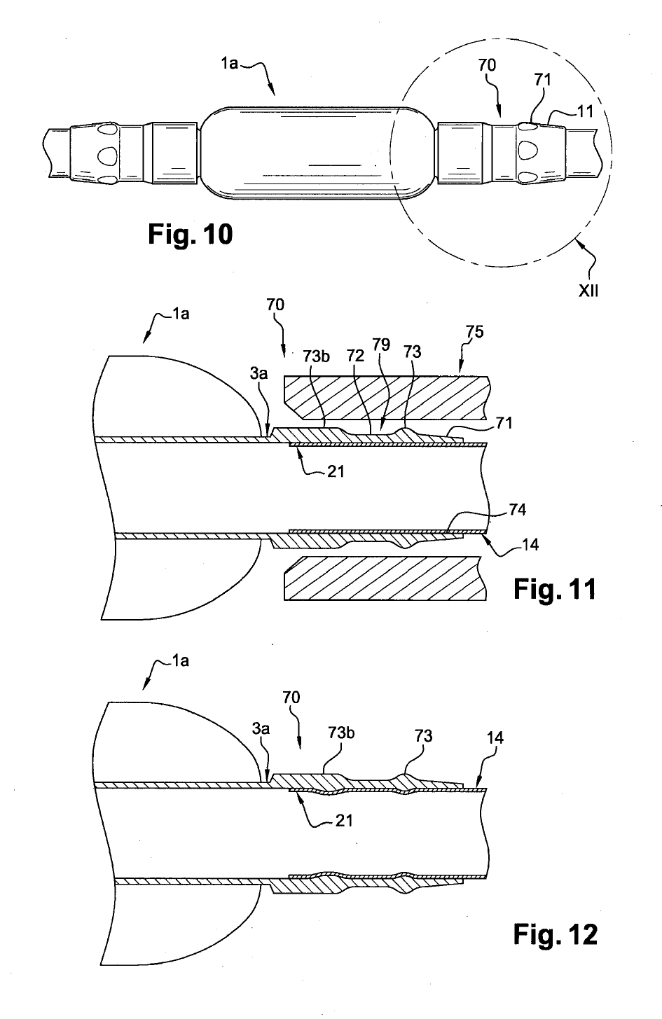

FIG. 10 represents schematically a device for coupling tubes according to a second variant of the invention comprising a first coupling for dissipating the electric charges and two second couplings connecting respectively the first and second tube to a pipe of the fluid circuit;

FIG. 11 is a cross-sectional view mainly representing the second coupling of FIG. 10 before crimping;

FIG. 12 is a cross-sectional view of circled part XII of FIG. 8 mainly representing the second coupling after crimping;

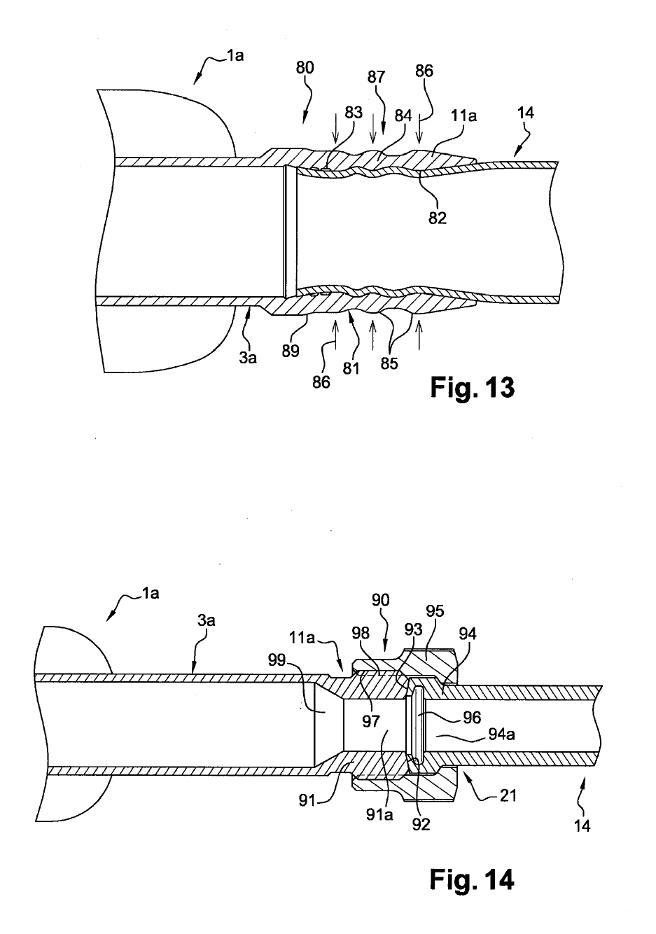

FIG. 13 is a cross-sectional view mainly representing the second coupling after crimping according to a third variant;

FIG. 14 is a cross-sectional view mainly representing the second coupling of a detachable type according to a fourth variant;

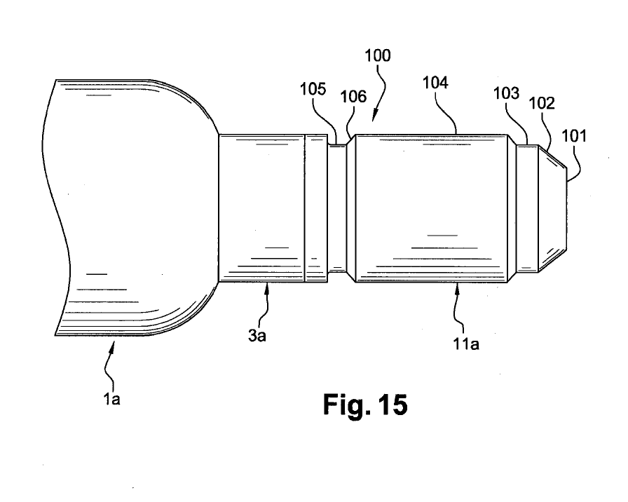

FIG. 15 is a side view representing a portion of a second detachable coupling according to a fifth variant.

Reference is made to FIG. 2, in which a first coupling 1a for dissipating the electric charges is represented, this coupling being able to be dielectric coupling 1 described above or any other coupling providing for the circulation of fluids, as well as first 3a and second 5a tubes, for which this first coupling 1a provides the connection. In this figure, there are also represented by dotted lines respective ends 2a, 4a of these first and second tubes 3a, 5a, which are held fixed relative to one another being coaxially disposed with respect to one another, such that the fluids circulate through coupling la in a secure manner.

According to this FIG. 2, a second coupling 13 is located at opposite end 11a of first tube 3a. This second coupling connects second tube 3a to a pipe 14 of the fluid circuit.

A second identical coupling 13a is mounted at opposite end 12a of second tube 5a. For the sake of clarity, only the second coupling secured to first tube 3a will be described in detail in all the embodiments described by reference to FIGS. 2 to 15, all the elements relating to this second coupling 13 being able to be applied to the other second coupling 13a secured to second tube 5a.

With reference to FIGS. 2 and 5, second coupling 13 comprises a female coupling portion 15 which is fitted onto a combined male coupling portion 16 comprising a crimping zone 17 providing for the fixing of first tube 3a to this male coupling portion 16.

As can be seen in FIG. 5, male coupling portion 16 comprises a nose 26 which is extended by a shoulder 28 and a rear cylindrical portion 28a.

Female coupling portion 15 comprises a front portion with a conical inner surface 19 resting on nose 26 of male coupling portion 16 and held in this position by means of a screw nut 18, inner face 20 whereof has in part the shape of shoulder 28 of male coupling portion 16 and comprises a tapped zone 19a located in a threaded combined zone 19b made on the outer surface of female coupling portion 15.

The threaded joint of screw nut 18 on the female coupling portion 15 provides for the fixing of this female coupling portion 15 on male coupling portion 16 and endows this fixing with a detachable character.

Female coupling portion 15 is present in the form of a sleeve comprising a crimping zone 15a having two bosses 15b, 15c capable, under the effect of the clamping action of a crimping collar not represented, of compressing the sleeve by concurrently causing the plastic deformation of the inner surface of this female coupling portion 15 in its crimping zone 15a and the deformation of end 21 of pipe 14. The crimping process employed as well as the sleeve engaged in the crimping zone will be described in greater detail by reference to the embodiment of FIGS. 10 to 12.

The crimping of first tube 3a is described by reference to FIGS. 3 and 4. This crimping operation is also described in publication U.S. Pat. No. 6,108,895.

In these figures, male coupling portion 16 is fitted into a female die 20. End 11a of first tube 2a being the object of the crimping is introduced into male coupling portion 16 up to a stop 22 made in female die 20.

Female die 20 comprises a base 23 which is extended at the side of male coupling portion 16 by a tubular portion 24, whereof inner surface 25 is conical and rests on nose 26 of male coupling portion 16.

A crimping collar 30 surrounds male coupling portion 16 at its shoulder 26, inner surface 31 of crimping collar 30 being in contact with shoulder 28.

Crimping collar 30 is operated by displacement towards female die 20. Its inner surface 31 is such that this displacement combined with the presence of tubular portion 24 of the female die forming a stop for shoulder 28 of male coupling portion 16 first leads to an axial compression of nose 26 of male coupling portion 16 against inner surface 25 of female die 20, then a radial compression of this male coupling portion 16 on first tube 2a resulting in a permanent deformation of nose 26 of male coupling portion 16 and crushing of shoulder 28 of this same male coupling portion 16. These two deformations compress first tube 2a which is deformed without being able to resume its initial shape due to the permanent deformation of male coupling portion 16.

Nose 26 and shoulder 28 of male coupling portion 16 are defined as being crimping zone 17 of second coupling 13.

The assembly formed by male coupling portion 16 and first tube 2a is then extracted from female die 20 and from crimping collar 30 so as to be fitted into female coupling portion 15 as shown in FIG. 5.

Screw nut 18 then secures male coupling portion 16 to female coupling portion 15.

By reference to FIGS. 6 and 7, the device for coupling tubes comprises, in addition to first coupling 1a, a second coupling 35 comprising a sleeve 36 and two crimping rings 37, 38.

The second coupling is described more precisely by reference to FIG. 7 and is also described in publication WO95/05556.

The configuration of this second coupling 35 is symmetrical in that sleeve 36 comprises an annular central recess 39 forming a axis of symmetry XX′, this annular recess 39 being limited by two stops 40, 41, which are in each extended by an initially tubular portion 42, 43 before the crimping operation forming respectively crimping zone 58a, 58b.

End 11a of first tube 3a and end 21 of pipe 14 are introduced into sleeve 36 in the vicinity of central annular recess 39.

Crimping rings 37, 38 are each constituted by an annular insert 42, 43 and an annular collar 44, 45 made in different materials, for example annular inserts 42, 43 can be made of titanium and annular collars 44, 45 made of epoxy resin reinforced with high-resistance graphite fibres.

In order to perform the crimping operation, crimping rings 37, 38 are operated by displacement along arrows 46, 47. The combined shapes of respective inner surfaces 48, 49 of annular inserts 42, 43 and of respective outer surfaces 50, 51 of initially tubular portions 42, 43 of sleeve 36, as well as the presence of respective annular recesses 52, 53 located on respective inner surface 54, 55 of annular inserts 42, 43 lead to the permanent deformation by radial compression of initially tubular portions 42, 43 and the concurrent deformation of respective ends 11a, 21 of first tube 3a and of pipe 14, for which this second coupling 35 ensures the secure connection.

FIGS. 8 and 9 illustrate a first variant of the invention. In this variant, second coupling 60 corresponds to a portion of coupling 35 of the example of FIGS. 6 and 7 along axis of symmetry XX′ referred to in this example. The elements already described in the preceding example are therefore found therein, i.e. a sleeve 61 comprising a crimping zone 68, a crimping ring 62 made of an annular insert 63 and an annular collar 64, all these elements being identical to the corresponding elements of second coupling 35 of the preceding example. The crimping operation takes place as described for the preceding example by axial displacement of crimping ring 62 towards stop 65 of sleeve 61 forming end 11a of first tube 2a.

Moreover, as can be seen in FIG. 9, sleeve 61 forms an integral part of end 11a of tube 3a. This sleeve 61 can be produced for example by machining on end 11a of first tube 3a which is metallic.

This variant is very advantageous, since the connection of pipe 14 to tube 2a requires only a single crimping operation instead of two according to the preceding example. Moreover, the total length of second coupling 60 is reduced by half compared with that of second coupling 35 of the preceding example. Consequently, the total mass of the second coupling is also reduced with a mass saving of approximately 45% compared to second coupling 35 of the second variant.

In the same sense, the second variant represented in FIGS. 10 and 12 includes a second coupling 70, which is present in the form of a sleeve 71 also forming end 11a of first tube 2a.

As represented in FIG. 11, before crimping, sleeve 71 of second coupling 70 comprises on its outer surface 72 a first annular boss 73a and a second annular boss 73b with a plane flat zone forming crimping zone 79. Inner surface 74 of sleeve 71 is tubular. End 21 of pipe 14 is introduced into sleeve 71 of second coupling 70 in the vicinity of first coupling 1a.

The crimping operation is carried out by means of a crimping collar 75 represented in FIG. 11. This crimping collar 75 is placed opposite sleeve 71 and is operated by clamping in such a way as to compress sleeve 71 leading concurrently to the plastic deformation of inner surface 74 of this sleeve and the deformation of pipe 14. The person skilled in the art will adapt the geometry of the crimping collar to the previously described crimping operation.

Finally, the third variant is also in accordance with the principle of the first and second variants. Referring to FIG. 13, second coupling 80 is present in the form of a sleeve 81 machined on end 11 of first tube 3. This second coupling 80 and the corresponding crimping operation are described in publication FR 2 899 307.

Outer surface 89 of sleeve 81 comprises a series of bosses 85 forming crimping zone 87, on which a radial crimping force is applied according to arrows 86 by a suitable tool (not represented) which leads to a permanent compressive deformation of sleeve 81 and which also leads to a concurrent deformation of end 21 of pipe 14 to be connected.

Moreover, inner surface 82 of sleeve 81, which is in contact with end 21 of pipe 14, comprises a glued portion 83 which is glued by a glue with a plurality of components, one of which is encapsulated in such a way that, before crimping, this glued portion does not perform its gluing function.

In contrast, when the radial crimping force is applied according to arrows 86, the glue is released and contributes to keeping in place end 21 of pipe 14 in sleeve 81.

If all the previously described devices permit first 3a and second 5a tubes to be connected, themselves connected by first coupling 1a, to pipe 14 of the fluid circuit, the first, second and third variants are particularly advantageous, since they reduce the mass of the second coupling compared to the examples described by reference to FIGS. 2 to 6, they reduce the space requirement caused by the presence of this second coupling and can easily be produced by machining at end 11a of first tube 3a.

FIGS. 14 and 15 describe two embodiments which do not involve a crimping zone, but a second coupling comprising a first coupling portion and a second coupling portion capable of being separated, from which it follows that this second coupling is detachable. Moreover, according to the invention, the one or the other of the first or second portions is created at end 11a of first tube 3a exiting from first coupling 1a.

More particularly, the coupling portions located at end 11a of first tube 3a are produced by an operation of machining this end 11a of first tube 3a.

By reference to FIG. 14, second coupling 90 comprises a first portion 91 in the form of a sleeve which is machined at end 11a of first tube 3a exiting from first coupling 1a.

This first coupling portion 91 has a female truncated end surface 92 which coincides with male truncated end surface 93 of second coupling portion 94 machined at end 21 of pipe 14. Respective end surfaces 92, 93 of first 91 and second 94 coupling portions are supported in contact by means of a screw nut 95, the inner face whereof comprises a tapped zone 97 located in a threaded combined zone 98 made on the outer surface of first portion 91.

Tubular fluid-circulation zone 91a in first coupling portion 91 and tubular fluid-circulation zone 94a in second coupling portion 94 are disposed coaxially with respect to one another in such a way as to secure the circulation of the fluid through second coupling 90.

The tightening of screw nut 95 ensures the fixed holding of first coupling portion 90 on second coupling portion 94. The loosening of the screw nut, on the other hand, permits the detachment of first coupling portion 90 from second coupling portion 94.

Moreover, the second coupling portion comprises an annular neck 96 which widens the diameter of pipe 14 at a point and endows this second coupling portion 94 with an elasticity permitting this second coupling portion 94 and a second coupling 90 in its entirety to retain their properties, and in particular their tightness properties.

In this example of embodiment, the diameter of pipe 14 is less than the diameter of first tube 3a, which requires the presence of a narrowing zone 99 located at first coupling 90. It is understood that this embodiment also applies to a configuration in which the diameters of first tube 3a and pipe 14 are identical. The person skilled in the art will know how to adapt first coupling 90 to such a configuration.

By reference to FIG. 15, according to the same principle as for the embodiment represented in FIG. 14, the second coupling comprises a first coupling portion 100 machined at end 11a of first tube 3a exiting from first coupling 1a.

This first coupling portion 100 is also present in the form of a sleeve and comprises, from its first end portion 101, a first truncated portion 102 increasing its external diameter, a first plane surface 103, a second truncated portion 104 increasing its external diameter, a second plane surface 104 and an annular neck 105 connected to second plane surface 104 by a third truncated portion 105.

The second coupling portion is not represented in this figure, but the person skilled in the art will know how to adapt it to this first coupling portion to form a second tight and detachable coupling. For example, the second coupling portion will comprise an inner truncated surface having the shape of and being fitted at least in part on first truncated portion 102 of the first coupling portion and being held fixedly in this position by means of a lock nut.

1. A device for coupling fluid-circulation tubes comprising:
a first coupling connecting a first and a second tube, in which first coupling the respective ends of the first and second tubes are disposed coaxially with respect to one another, wherein at least one of the opposite ends of the first and second tubes is capable of being secured to a second coupling which is configured to couple the first or second tube to a pipe of a fluid circuit, said second coupling comprising a portion which is made in one piece with the at least one opposite end, such that the portion of the second coupling forms the at least one of the opposite ends of the tube.

2. The device according to claim 1, wherein the second coupling comprises a crimping zone which endows it with the capacity to be fixed by a crimping operation at an end of the pipe of a fluid circuit.

3. The device according to claim 2, wherein the second coupling is a sleeve forming the opposite end of the tube and comprising a crimping zone providing the crimping of the pipe by application of a radial compressive force in this crimping zone.

4. The device according to claim 3, wherein the sleeve comprises a collar forming a crimping arrangement by axial displacement along said sleeve during the crimping operation.

5. The device according to claim 1, wherein the second coupling comprises a first coupling portion forming an end of the tube, said first coupling portion is capable of being held fixedly relative to a second combined coupling portion which is secured to the pipe of the fluid circuit, the first and second coupling portions in their fixed position relative to one another comprising an arrangement configured to provide for the secure circulation of the fluids through the second coupling.

6. The device according to claim 5, wherein the first coupling portion and the second combined coupling portion comprise a fastener configured to render them capable of being held fixedly relative to one another in such a way as to be detachable by a screw nut.

7. The device according to claim 1, wherein the first coupling is a dielectric coupling comprising a dissipator configured to dissipate the electric energy generated by the movements of fluids circulating in the first and second tubes.

8. The device according to claim 1, wherein each of the opposite ends of the first and second tubes comprises a second coupling comprising at a portion which is made in one piece with the opposite of the tube.

9. The device according to claim 1, wherein the first and second tubes and the pipe are metallic.

10. A method for using the device according to claim 1, the device comprising a first coupling connecting a first and a second tube, in which first coupling the respective ends of the first and second tubes are disposed coaxially with respect to one another, in which device at least one of the opposite ends of the first and second tubes is capable of being secured to a second coupling which is configured to couple the first or second tube to a pipe of a fluid circuit, said second coupling comprising a portion which is made in one piece with the at least one opposite end, said method comprising machining the portion of the second coupling at the at least one opposite of the opposite ends of the tube.

11. A device for coupling fluid-circulation tubes, the device comprising:
a first coupling configured to connect a first and a second tube, a first end of each of the first and second tubes being disposed substantially coaxially with respect to one another in the first coupling, wherein a second end of one of the first and second tubes is capable of being secured to a second coupling which is configured to couple said one of the first and second tubes to a pipe of a fluid circuit, said second coupling comprising a portion which is made in one piece with the second end of said one of the first and second tubes, such that the portion of the second coupling forms the second end of said one of the first and second tubes.
